(19) United States
(12) Patent Application Publication
(10) Pub. No.: US 2004/0054969 A1
(43) Pub. Date: Mar. 18, 2004

(54) System and method for generating web services definitions for MFS-based IMS applications

(75) Inventors: Chenhuei J. Chiang, San Jose, CA (US); Shyh-Mei F. Ho, Cupertino, CA (US); Jenny Chengyin Hung, Fremont, CA (US); Benjamin Johnson Sheats, San Jose, CA (US)

Correspondence Address: John L. Rogitz, Rogitz & Associates, Suite 3120, 750 B Street, San Diego, CA, 92101, US

(73) Assignee: International Business Machines Corporation, Armonk, NY

(21) Appl. No.: 10/244,710

(22) Filed: Sep. 16, 2002

(51) Int. Cl. G06F 9/45

(52) U.S. Cl. 715/513

(57) ABSTRACT

A system and method for generating WSDL files based on MFS-based IMS applications includes receiving an IMS message byte stream and translating the byte stream to an MFS XML document. An MFS WSDL file is generated from the MFS XML document. The MFS WSDL file can be published at a UDDI directory.

### I. FIELD OF THE INVENTION

The present invention relates generally to computer software, and more specifically to IMS software.

### II. BACKGROUND OF THE INVENTION

By some estimates, nearly seventy percent (70%) of corporate data in the United States and abroad resides on mainframe computers, e.g., S/390 mainframes manufactured by International Business Machines. Moreover, business-to-business (B2B) e-commerce is expected to grow at least five times faster than the rate of business-to-consumer (B2C) e-commerce. Many transactions involving this corporate data can be initiated by Windows/NT servers, UNIX servers, and other servers but the transactions must be completed on the mainframe using existing legacy applications residing thereon.

One very crucial group of legacy applications are the message format service-based information management system applications (MFS-based IMS applications) on which many businesses depend heavily. MFS is a facility of the IMS transaction management environment that formats messages to and from many different types of terminal devices. As businesses upgrade their technologies to exploit new B2B technologies, there is a requirement for an easy and effective method for upgrading existing MFS applications to include e-business capabilities. One such e-business capability is the ability to send and receive MFS-based IMS transaction messages as extensible markup language (XML) documents.

The MFS language utility compiles MFS source, generates MFS control blocks in a proprietary format, known as Message Input/Output Descriptors (MID/MOD), and places them in an IMS format library. MFS supports several terminal types, e.g., IBM 3270 terminals, and it was designed so that the IMS application programs using MFS do not have to deal with any device-specific characteristics in the input or output messages. Because MFS provides headers, page numbers, operator instructions, and other literals to the device, the application=s input and output messages can be built without having to pass these formal literals. MFS identifies all fields in the message response and formats these fields according to the specific device type. This allows application programmers to concentrate their efforts on the business logic of the programs.

Because the IMS application program input/output data structures do not fully describe the end user interaction with these existing MFS applications, there exists a need for a means to deal with information that is buried within various MFS statements. Examples of this information includes 3270 screen attribute bytes and preset function key (PFKey) input data. Many MFS-based IMS application programs are passed PFKey data in input messages, but application logic is not required to recognize that a certain PFKey was pressed and a literal corresponding to that PFKey must be inserted into the input message. This is due to the fact that, at runtime, it is the MFS online processing and not the application that places the literal that corresponds to the PFKey pressed into the appropriate field in the input message.

XML has become the preferred data format to support Web services, B2C and B2B interchanges. However, presently, there does not exist any way by which hypertext transfer protocol (HTTP) requests can be presented to an IMS application and HTTP responses returned.

Additionally, as corporations upgrade, it may be necessary for them to publish their services online so that they can be found thereon. The universal description, discovery, integration (UDDI) directory is the standard directory in which businesses can be found online. UDDI servers act as a directory of available services and service providers. Web service description language (WSDL) is an extensible mark-up language (XML) format that can be used to describe Web services. It introduces an extensible grammar for describing message endpoints while leveraging XML Schema Definition (XSD) for defining message content.

WSDL describes Web services starting with the messages that are exchanged between the service provider and the requestor. The messages are described abstractly and then, bound to a concrete network protocol and message format. A message consists of a collection of typed data item. WSDL does not define its own data typing language. Instead, it defers that task to existing type languages such as XML Schema and provides a mechanism to “host” any number of type definitions from such languages. WSDL recognizes that using XML Schema as the type system language results in maximum interoperability of Web services described in WSDL. Thus, it is recommended that the XML Schema type system is used, whenever possible, to describe messages exchanged between Web services. Also, simple object access protocol (SOAP) can be used to query the UDDI for web services. Presently, there does not exist a method for generating WSDL files from MFS source files.

Accordingly, there is a need for a system and method which will facilitate the accessibility of MFS-based IMS applications using documents formatted in XML. There is also a need for a system and method for generating WSDL files from MFS source files.

### SUMMARY OF THE INVENTION

A computer program for generating WSDL files from MFS source files and consuming WSDL files at runtime. The program includes logic means for receiving and sending XML based documents such as SOAP messages. Also, the program includes logic means for generating an MFS WSDL file from the MFS XML document. The MFS WSDL file captures all the aspects of the MFS source files. Then, the user can publish the MFS WSDL file to a UDDI. The program further includes logic means for generating the MFS SOAP handlers based on the MFS source files. The MFS SOAP handlers contain logic means for translating SOAP messages into MFS XML documents and vice versa. Moreover, the program includes logic means for translating the MFS XML document into IMS message byte stream, and vice versa, using an MFS XML adapter. In a preferred embodiment, the IMS message byte stream is sent and received via IC4J to and from an IMS MFS host application.

In another aspect of the preferred embodiment of the present invention, a computer program for generating MFS WSDL files from MFS source files includes logic means for translating an IMS message byte stream to an MFS XML document and logic means for generating an MFS WSDL file from the MFS XML document.

In yet another aspect of the preferred embodiment of the present invention, a method for publishing web services to a UDDI directory includes receiving an MFS WSDL file. The MFS WSDL file is at least partially based on an MFS IMS source file.

In still another aspect of the preferred embodiment of the present invention, a method for generating an MFS WSDL file from an MFS XML document includes receiving an IMS message byte stream and translating the IMS message byte stream to an MFS XML document. An MFS WSDL file is generated according to the MFS XML document.

In yet still another aspect of the preferred embodiment of the present invention, a method for generating an MFS WSDL file from an IMS message byte stream includes translating an IMS message byte stream to an MFS XML document and generating a WSDL file from the MFS XML document.

The preferred embodiment of the present invention will now be described, by way of example, with reference to the accompanying drawings, in which:

### BRIEF DESCRIPTION OF THE DRAWINGS

FIG. 1 is a flow chart of the overall logic of the present invention;

FIG. 2 is a flow chart of the general translation logic of the present invention;

FIG. 3 is a flow chart of the XML/MFS translation logic of the present invention;

FIG. 4 is a flow chart of the WSDL generating logic;

FIG. 5 is a flow chart of the web services invocation logic;

FIG. 6 is a diagram of an MFS to XSD mapping model; and

FIG. 7 is a block diagram of a system architecture.

### DESCRIPTION OF AN EMBODIMENT OF THE INVENTION

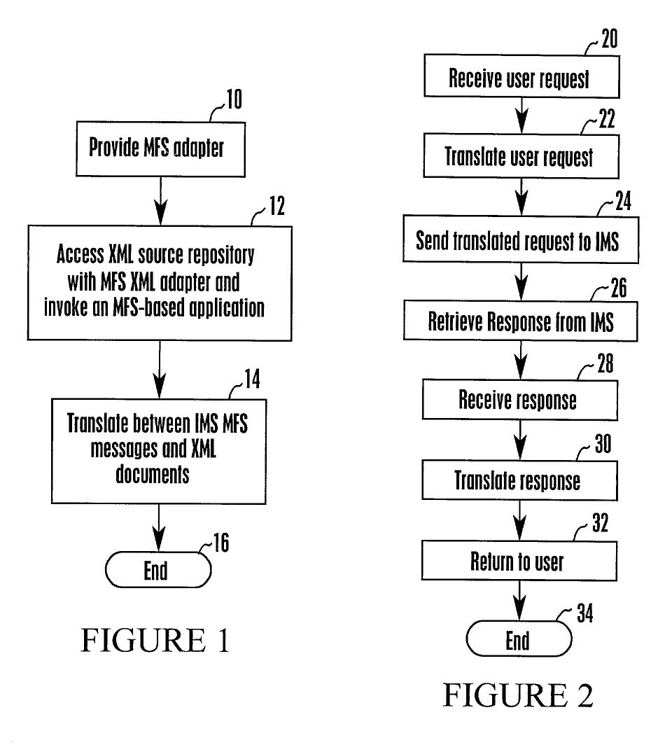

Referring initially to FIG. 1, the overall operating logic of the present invention is shown and commences at block 10 wherein an MFS XML adapter is provided. As described below, the MFS XML adapter includes a mapper which maps the XML document pertaining to the device information into the appropriate MFS XML messages (and vice versa). Also, the MFS XML adapter includes a converter that transforms the MFS XML messages into a byte stream and vice versa. The MFS mapper reads and parses MFS source files for a particular application and generates XMI files that describe the MFS-based application interface using the MFS Metamodel discussed in U.S. patent application Ser. No. 09/849,105 filed on May 4, 2001, incorporated herein by reference, which is part of the Common Application Metamodel (CAM) disclosed in U.S. Patent Application, serial No. 60/223,671 filed on Aug. 8, 2000, also incorporated herein by reference.

It is to be understood that there are three external reference pointers to a particular MFS source file: message input descriptor (MID), message output director (MOD), and table. The MFS mapper generates three XMI files for the three external reference pointers. These three files include a “midname.xmi” file for each MID with its associated device input format (DIF), a “modname.xmi” file for each MOD with its associated device out put format (DOF), and a “tablename.xmi” file. These XMI files represent all the application interface information encapsulated by the MFS source including the input and output messages, display information, MFS flow control, device characteristics and operation semantics. With these XMI files and the MFS converter, MFS-based IMS applications can support B2B XML communication without altering the MFS-based IMS application.

Returning to FIG. 1, at block 12, the MFS XML adapter has access to an XML source repository and can properly invoke an MFS-based IMS application. It can be appreciated that the MFS-based IMS application contains corporate data, e.g., airline reservation data, rental car availability data, credit data, inventory data, news data, weather data, scheduling data, etc. Continuing to block 14, the MFS XML adapter is used to translate between IMS MFS messages and XML documents. The logic then ends at state 16. As described in greater detail below, the above logic allows a client program to access an MFS-based IMS application via the Internet.

FIG. 2 shows the general translation logic utilized by the MFS XML adapter. Beginning at block 20, a client request (or, a user request), e.g., an HTTP XML document or a SOAP XML document, is received at the MFS XML adapter. At block 22, the MFS XML adapter translates the client request to an IMS MFS message, the XML/MFS translation logic is described in greater detail below. Moving to block 24, the translated request is sent to the MFS-based IMS application. Next, at block 26, a response to the translated request is retrieved from the MFS-based IMS application. Continuing to block 28, the response is received at the MFS XML adapter. The response is translated, at block 30, from an IMS MFS message to the format of the client request, e.g., HTTP XML, SOAP XML, etc. Proceeding to block 32, the translated response is returned to the client program. The logic then ends at state 34.

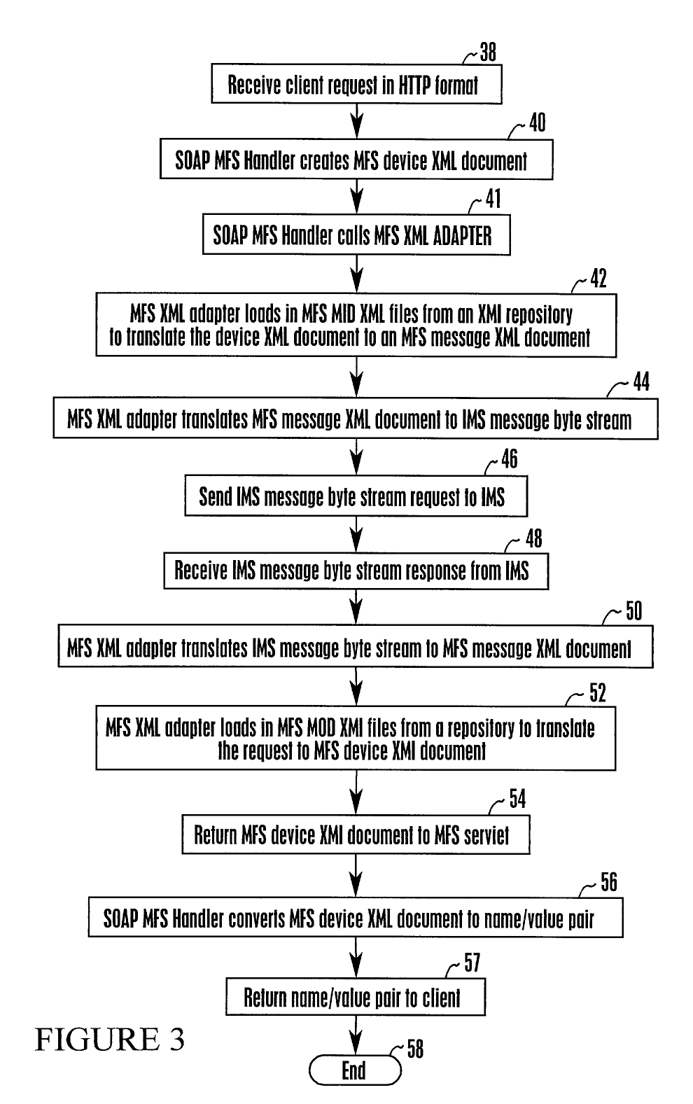

Referring now to FIG. 3, the XML/MFS translation logic is shown and commences at block 38, wherein a client request is received at a SOAP RPC router. Next, at block 40, a SOAP MFS Handler creates an MFS device XML document. At block 41, the SOAP MFS Handler calls the MFS XML adapter and sends the MFS device XML document to the MFS XML adapter. Proceeding to block 42, the MFS XML adapter loads in MFS MID XML files from an XMI repository to translate the device XML document to an MFS message XML document. Moving to block 44, the MFS XML adapter translates the MFS message XML document to an IMS message byte stream. Next, at block 46, the IMS message byte stream request is sent to the MFS-based IMS application. Continuing to block 48, an IMS message byte stream response is received by an MFS XML adapter. At block 50, the MFS adapter translates the IMS message byte stream to an MFS message XML document. Then, at block 52, the MFS XML adapter loads in MFS MOD XMI files from an XMI repository to translate the request to an MFS device XMI. Moving to block 54, the populated MFS XMI document is returned to the MFS servlet. At block 56, the SOAP MFS Handler converts the MFS device XML document to a name/value pair. Then, at block 57, the name/value pair, encapsulated as payload in a SOAP message, is returned to the client, e.g., to the client=s web browser. The logic then ends at state 58.

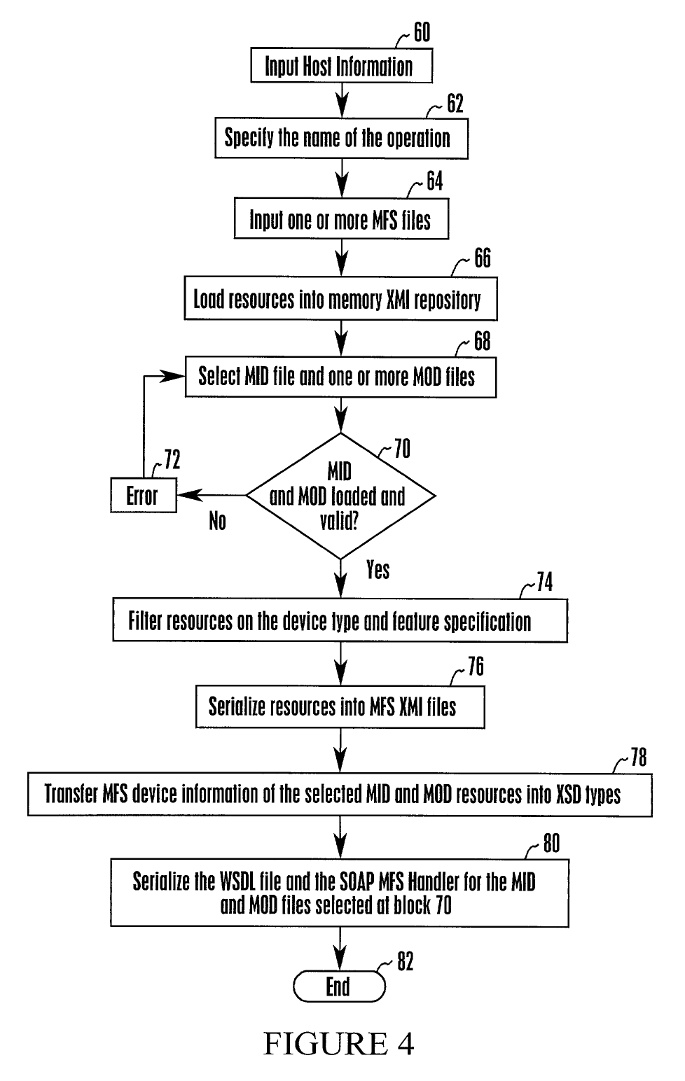

Referring to FIG. 4, the WSDL generating logic is shown and commences at block 60 wherein host information, i.e., IMS information and namespace is preferably input by the client. It is to be understood that the IMS information can include: hostname, port number, datastore, and security information. At block 62, the name of the new operation is specified by the client. Moving to block 64, the client selects one or more MFS files and the MFS mapper loads them into memory. At block 66, existing resources are loaded into memory from an XMI repository. Each of the resources is a MID file or a MOD file. Moving to block 68, a MID file and one or more MOD files are selected. In a preferred embodiment, the client is prompted to selected a MID file, but an associated MOD file is selected automatically. Additional MOD files can also be selected.

Continuing to decision diamond 70, it is determined whether the selected MID and MOD files are loaded and valid. If not, an error message is presented to the user, at block 72, and the logic returns to block 68 so that different MID and MOD files can be selected. If the selected MID and MOD files are loaded and valid, the logic moves to block 74 where the resources are filtered on the device type and the feature specification. Next, at block 76, the resources are serialized into MFS XMI files. Proceeding to block 78, MFS device information of the selected MID and MOD resources are transferred into XML schema definition (XSD) types based on the MFS to XSD mapping model, described below. Next, at block 80 the MFS XML adapter serializes the WSDL file and the SOAP MFS Handler for the MID and MOD files selected above. It is to be understood that SOAP MFS handler includes means for routing SOAP requests and responses and for invoking proper operation. Preferably, the SOAP MFS handler maps the name/value data from a standard SOAP handler, e.g., an reprouter, to simulated device input XMI which is sent as input to the MFS XML handler. The logic then ends at state 82.

It is to be understood that the MFS XML adapter transforms existing MFS-based IMS applications into web services by supporting SOAP bindings for accessing web services. Moreover, it is to be understood that WSDL is an XML-based language used to describe web services that a business offers and to provide a way for individuals and business to access those services electronically. Also, WSDL is an XML format for describing the network services that handle procedural or document-oriented information. These descriptions define endpoints that are bound to a particular network protocol. The WSDL files can be published at a UDDI registry to enable public access to the web service.

It is also to be understood that the MFS WSDL file is preferably based only on the device side. Specifically, on the input side, device information of the MID is mapped into XSD types that are referenced as the operation=s input message. On the output side, device information of the MOD is mapped into XSD types that are referenced as the operation=s output message. In a preferred embodiment, when mapping to XSD types, only the device fields which map to message fields are included. Also, in a preferred embodiment, literals are not included—except for system-literals. Additionally, for the input part, the input logical pages are enclosed in a choice statement, thus restricting one logical page to be used as input. For the output part, the output logical pages are enclosed in a sequence statement, allowing multiple occurrences of any output logical page as output.

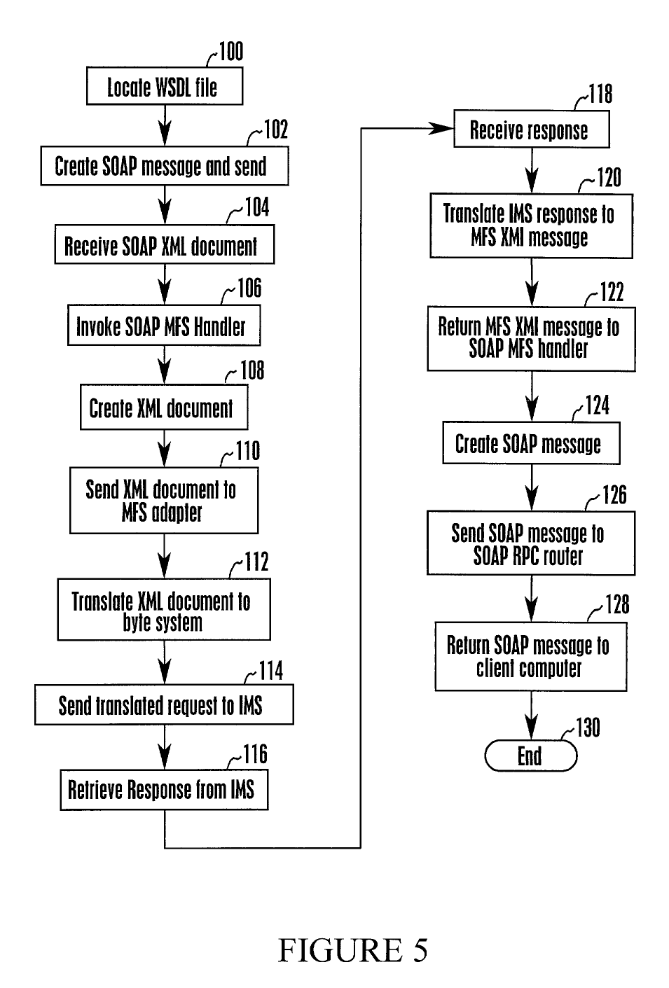

Referring now to FIG. 5, the web services invocation logic is shown and commences at block 100 where the WSDL file, generated above, is preferably located by the web services client. Next, at block 102, the web services client creates a SOAP message based on the WSDL and sends it to a SOAP RPC Router. The SOAP message created by the client has a payload that is all strings, with names matching the device field labels chosen from the device input field (DIF). Moving to block 104, the SOAP XML document is received at the SOAP RPC router. At block 106, the SOAP MFS handler corresponding to the router is invoked with payload data from the SOAP XML document. Continuing to block 108, an XML document simulating the device input XMI is created by the SOAP MFS handler. Then, at block 110, the XML document is sent to the MFS XML adapter.

Proceeding to block 112, the MFS XML adapter translates client requests to byte stream based on meta-data information stored in the MID XMI file. Moving to block 114, the translated request is sent to the MFS-based IMS application. Next, at block 116, a response to the translated request is retrieved from the MFS-based IMS application. Continuing to block 118, the response is received at the MFS XML adapter. At block 120, the MFS XML adapter translates the IMS response to an MFS XMI message with the meta-data information stored in the MOD XMI file. Then, at block 122, the MFS XML adapter returns the MFS XMI message to the SOAP MFS handler. The SOAP MFS handler creates a SOAP message at block 124. At block 126, the SOAP message is sent to the SOAP RPC router. Proceeding to block 128, the SOAP message is returned to the client. The logic then ends at state 130.

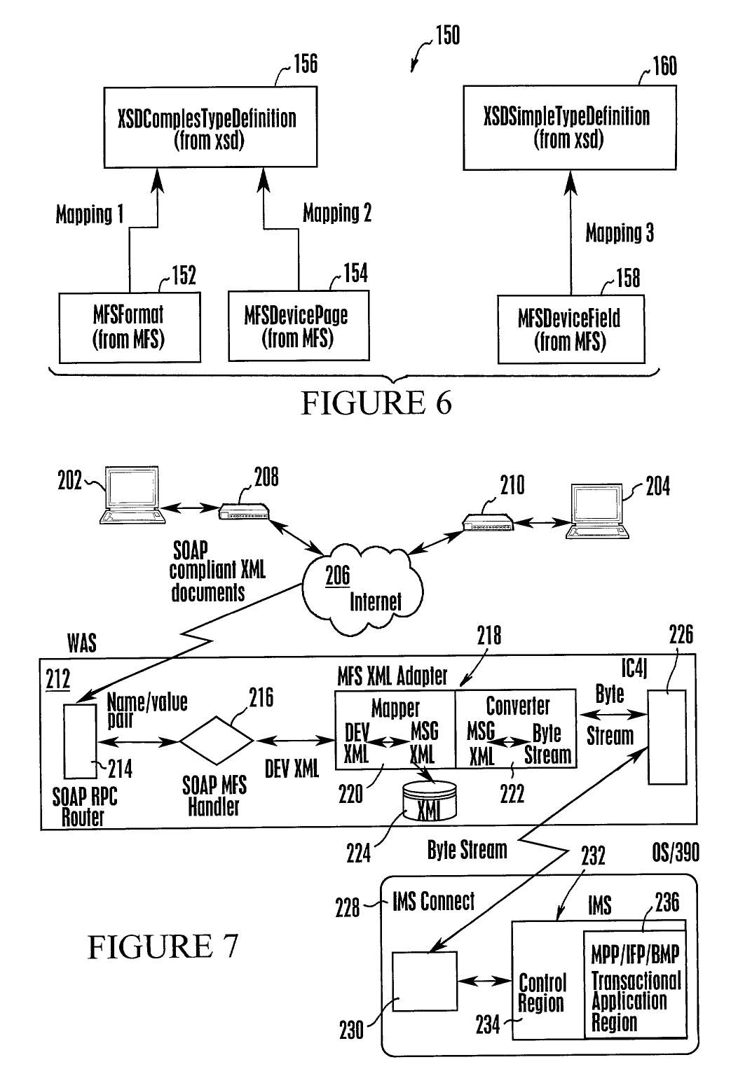

It to be understood that the mapping, described above, occurs on the following elements: MFSFormat, MFSDevicePage, and MFSDeviceField as shown in FIG. 6, which is an MFS to XSD mapping metamodel, generally designated 150. FIG. 6 shows that MFSDeviceField 152 and MFSDevicePage 154 are mapped to XSDComplexTypeDefinitions 156. On the other hand, MFSFormat 158 is mapped into XSDSimpleTypeDefinition 160. It is to be understood that only the MFSDeviceFields that are referenced by an MFSMessageField are used.

It is also to be understood that the MFSFormat 152 represents the MFS FMT statement. The FMT statement initiates and names a format definition that includes one or more device formats as represented by MFSDevice. Each device consists of 1 or 2 divisions as represented by MFSDivision. Each division consists of 1 or more device pages as represented by MFSDevicePage.

The mapping from MFSFormat 152 to XSDComplexTypeDefinition 156 translates into a choice of logical pages for input and into a sequence of logical pages array for output. In the case of input, the element name reflects the logical page no in ascending order. In the case of output, the logical pages array has a size of 0 to unlimited as specified in the minOccurs and maxOccurs attributes. The logical pages array holds a choice of XSDComplexTypes, where each represents a logical pages with the element name reflecting the logical page no in ascending order.

Further, the MFSDevicePage 154 represents the MFS DPAGE statement. It describes the grouping of a logical page of a device format. It consists of 1 or more physical pages (implicitly defined) and each physical page consists of 1 or more DFLDs. The mapping from MFSDevicePage 154 to XSDCompleTypeDefinition 156 translates into a sequence of field elements. Each field element, MFSDeviceField, is represented by XSDSimpleTypeDefinition. The element name reflects the physical page no and the name of the field. The order is in ascending order starting from physical page 1.

The MFSDeviceField 158 represents the MFS DFLD statement. It defines a field within a device format which is read from or written to a terminal or remote program. The attributes in particular interest to XSD mapping are the length and value attributes. The mapping from MFSDeviceField 158 to XSDSimpleTypeDefinition 160 stands if and only if an MFSMessage (belonging to the same MFSDevicePage) has a reference to the device field. The device field=s name, length, and value attributes are mapped to the XSD element=s name, length value, and annotation tags.

It is to be understood that XSDComplexTypeDefinition 156 is a XSD definition that contains sub-element, i.e. mixture of complex and simple types. It can contain a set of element declarations, element references, and attribute declarations. The declarations are not themselves types, but rather an association between a name and the constraints which govern the appearance of that name in documents governed by the element. XSDComplexTypeDefinition 158 is also used to represent multiple possible outputs. It contains a choice of output elements, each of which is of XSDComplexType. The name and type of the subelement resolves the reference to the output definition.

It is to be further understood that XSDSimpleTypeDefinition 160 is a XSD definition that is of simple data type, i.e. string, integer, etc. It can hold restriction to limit the data type and length value. For the purpose of MFS mapping, the XSD simple type is restricted to the base type String. An annotation tag is used to hold default values and data pattern for double byte character set (DBCS).

Table 1 is an exemplary, non-limiting MFS to XSD mapping table. Each MFS element shown is mapped into XSD types according to the constraint specified under the condition column. The XSD mapping into java types is also shown. Java outer classes are used for outer XSD complexTypes. Java inner classes are used for inner XSD complexTypes. Java Strings are used for XSD simpleTypes. It is to be understood, for XSD simpleType, the base is the string and the length attribute captures the length of the MFS deviceField. In the case where the default values are specified, the XSD annotation tags are used. Also, in the case where the field contains extended attribute specification of pure or mixed DBCS, the XSD annotation tags are used.

TABLE 1
MFS to XSD mapping table:

| | | | Generated |
|---|---|---|---|
| MFS Model Type | Condition | Corresponding XSD Type | Jave type |
| MFSFormat | | m = value of MFSMessage's label | |
| | | x = nth occurrence of MFSDevicePage | |
| | Corresponding | <xsd:complexType name=“m”> | Java class |
| | MFSMessage's | <xsd:choice> | |
| | type=“input” | <xsd:element name=“LogicalPagex”> | |
| | | . . . . | |
| | | </xsd:element> | |
| | | . . . | |
| | | </xsd:choice> | |
| | | </xsd:complexType> | |
| | Corresponding | <xsd:complexType name=“m”> | Java class and |
| | MFSMessage's | <xsd:sequence> | Java inner class |
| | type=“output” | <xsd:element maxOccurs=“unbounded” | |
| | | minOccurs=“1” name=“LogicalPages”> | |
| | | <xsd:complexType> | |
| | | <xsd:choice> | |
| | | <xsd:element name=“LogicalPagex”> | |
| | | . . . . | |
| | | </xsd:element> | |
| | | </xsd:choice> | |
| | | </xsd:complexType> | |
| | | </xsd:element> | |
| | | </xsd:sequence> | |
| | | </xsd:complexType> | |
| MFSDevicePage | | x = nth occurence of MFSPhysicalPage | |
| | | name = value of MFSDeviceField's label attribute | |
| | | <xsd:complexType> | Java inner |
| | | <xsd:sequence> | classes |
| | | <xsd:element name=“PPxname”> | |
| | | . . . | |
| | | </xsd:element> | |
| | | . . . | |
| | | </xsd:sequence> | |
| | | </xsd:complexType> | |
| | | n = length of the MFSDeviceField | |

Appendix 1 shows a non-limiting, exemplary MFS source file for a phonebook application. Also, Appendix 2, shows non-limiting, exemplary WSDL for an MFS based phonebook application having multiple possible outputs. FIG. 7 shows a system in which the above logic can be incorporated. For example, FIG. 7 shows a web application sphere (WAS) system, generally designated 200, in which SOAP compliant XML documents are utilized. As shown, the system 200 includes a first client computer 202 and a second client computer 204 that are connected to the Internet 206 by respective modems 208, 210. FIG. 7 shows that the Internet 206 provides a connection to a WAS 212. It is to be understood that at least one client program resides on the client computers 202, 204.

Within the WAS 212, is a SOAP RPC Router 214 that receives SOAP compliant XML documents. The router 214 constructs a name/value pair from the SOAP compliant XML documents and sends them to a SOAP MFS handler 216. The SOAP MFS handler 216 sends a DEV XML document to an MFS XML adapter 218 in which the logic depicted in FIGS. 2 and 3 resides. As shown in FIG. 7, the MFS XML adapter 218 includes an MFS mapper 220 and an MFS converter 222. The MFS mapper 220 is connected to an MFS XMI database 224. In accordance with the translation logic, the MFS mapper 220 and the MFS converter 222 work together to translate the DEV XML documents into a byte stream that is sent to an IC4J 226. The IC4J 226 sends the byte stream to a mainframe 228, e.g., an IBM S/390. At the mainframe, the byte stream is received by IMS connect (IC) 230 which, in turn, sends the byte stream to an IMS application 232 within the mainframe 228. FIG. 7 shows that the IMS application 232 includes a control region 234 and a transactional application program 236. It is to be understood that, in the above described WAS system 200, the translation between XML and byte stream occurs within the MFS XML adapter 218 that resides in the WAS 212.

It can be appreciated that in the exemplary system 200, described above, the client requests, e.g., HTTP XML documents or a SOAP XML documents, are received at an MFS XML adapter 218. The MFS XML adapter 218 converts the client requests into MFS-based IMS message byte streams and sends them to IMS applications 232 where they can be processed. The IMS application returns responses that are converted by the MFS XML adapter 218 back into HTTP XML documents or SOAP XML documents that can are rendered at one or more clients=web browsers. Thus, the MFS XML adapter 218 acts as a two-way translator to facilitate client interaction with IMS applications 232 via the Internet 206.

It is to be understood that in the system above, the translation logic can be contained on a data storage device with a computer readable medium, such as a computer diskette. Or, the instructions may be stored on a magnetic tape, hard disk drive, electronic read-only memory (ROM), optical storage device, or other appropriate data storage device or transmitting device thereby making a computer program product, i.e., an article of manufacture according to the invention. In an illustrative embodiment of the invention, the computer-executable instructions may be lines of C++ compatible code.

The flow charts herein illustrate the structure of the logic of the present invention as embodied in computer program software. Those skilled in the art will appreciate that the flow charts illustrate the structures of computer program code elements including logic circuits on an integrated circuit, that function according to this invention. Manifestly, the invention is practiced in its essential embodiment by a machine component that renders the program elements in a form that instructs a digital processing apparatus (that is, a computer) to perform a sequence of function steps corresponding to those shown.

With the configuration of structure described above, it is to be appreciated that system and method described above provides a means for receiving web-based client requests, translating them to MFS IMS, and submitting the translated requests to IMS applications. Thus, corporate data and other data that operates within MFS-based IMS application programs and that is typically accessed via terminals can be accessed via Internet connections. This allows corporations the option of allowing access to their data via the Internet.

While the particular SYSTEM AND METHOD FOR GENERATING WEB SERVICES DEFINITIONS FOR MFS-BASED IMS APPLICATIONS as herein shown and described in detail is fully capable of attaining the above-described aspects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. section 112, sixth paragraph, unless the element is expressly recited using the phrase “means for.”

[image]

[image]

[image]

[image]

[image]

[image]

[image]

[image]

[image]

[image]

[image]

[image]

[image]

[image]

[image]

[image]

1. A computer program for generating MFS WSDL files from IMS MFS source files, comprising:
logic means for receiving an IMS message byte stream;
logic means for translating the IMS message byte stream to an MFS XML document; and
logic means for generating an MFS WSDL file from the MFS XML document.

2. The program of claim 2, wherein the IMS message byte stream is received via MFS.

3. The program of claim 2, wherein the IMS message byte stream is translated to the MFS XML document using an MFS XML adapter.

4. A computer program for generating MFS WSDL files from MFS IMS source files, comprising:
logic means for translating an IMS message byte stream to an MFS XML document; and
logic means for generating an MFS WSDL file from the MFS XML document.

5. The program of claim 4, further comprising:
logic means for publishing the MFS WSDL file with a UDDI directory.

6. The program of claim 4, wherein the IMS message byte stream is received via MFS.

7. The program of claim 6, wherein the IMS message byte stream is translated to the MFS XML document using an MFS XML adapter.

8. A method for publishing web services to a UDDI directory, comprising the acts of:
receiving at least one MFS WSDL file, the WSDL file being at least partially based on an MFS IMS source file.

9. The method of claim 8, further comprising the act of:
publishing the MFS WSDL file with a UDDI directory.

10. The method of claim 8, wherein the MFS WSDL file is generated based at least partially on an MFS XML document.

11. The method of claim 10, wherein the MFS XML document is translated from an IMS message byte stream.

12. The method of claim 11, wherein the IMS message byte stream is received via MFS.

13. The method of claim 12, wherein the IMS message byte stream is translated to the MFS XML document using an MFS XML adapter.

14. A method for generating an MFS WSDL file from an MFS XML document, comprising the acts of:
receiving an IMS message byte stream;
translating the IMS message byte stream to an MFS XML document; and
generating an MFS WSDL file according to the MFS XML document.

15. The method of claim 14, further comprising the act of
publishing the MFS WSDL file at a UDDI.

16. The method of claim 15, wherein the IMS message byte stream is received via MFS.

17. The method of claim 16, wherein the IMS message byte stream is translated to the XML document using an MFS XML adapter.

18. A method for generating an MFS WSDL file from an IMS message byte stream, comprising the acts of:
translating an IMS message byte stream to an XML document; and
generating an MFS WSDL file from the XML.

19. The method of claim 18, further comprising the act of:
publishing the MFS WSDL file to a UDDI directory.

20. The method of claim 19, wherein the IMS message byte stream is received via MFS.

21. The method of claim 20, wherein the IMS message byte stream is translated to the XML document using an MFS XML adapter.
